(19) United States
(12) Patent Application Publication
(10) Pub. No.: US 2003/0191883 A1
(43) Pub. Date: Oct. 9, 2003

(54) Interface for upgrading serial backplane application from ethernet to gigabit ethernet

(75) Inventor: Steven J. April, Boxford, MA (US)

Correspondence Address: LAHIVE & COCKFIELD, 28 STATE STREET, BOSTON, MA, 02109, US

(73) Assignee: Sycamore Networks, Inc., Chelmsford, MA (US)

(21) Appl. No.: 10/117,363

(22) Filed: Apr. 5, 2002

(51) Int. Cl. G06F 13/14

(52) U.S. Cl. 710/305

(57) ABSTRACT

An interface device having a plurality of ports with a plurality of speed configurations for a serial backplane with 2-pair copper transmission lines, has a plurality of high speed Ethernet ports and a plurality of Gigabit Ethernet ports. A switch mechanism for selecting between the high speed Ethernet ports and the Gigabit Ethernet ports will connect the selected port to the serial backplane via the 2-pair copper transmission lines.

### CROSS REFERENCE TO RELATED APPLICATIONS

Not Applicable.

### STATEMENT REGARDING FEDERALLY SPONSORED RESEARCH

Not Applicable.

### REFERENCE CITED

### FIELD OF THE INVENTION

This invention relates generally to serial backplane application and more particularly to apparatus and methods for seamlessly upgrading Ethernet to Gigabit Ethernet while allowing Gigabit Ethernet and Ethernet to coexist in the same system for a serial backplane with 2-pair copper transmission infrastructure.

### BACKGROUND OF THE INVENTION

Typical telecom equipment such as SONET, SDH, ATM or Gigabit Ethernet switches use modular designs. Modules such as communication line cards are inserted in the sockets of an electronic circuit board to allow them to communicate with each other. The interface design of modules and backplanes constitute the “backbone” for the equipment. The backbone can be a traditional parallel mode bus with single-ended signaling, or a serialized interface with low voltage differential signaling. The topology of the backplane design can vary from point-to-point to multi-drop to multi-point connection.

As the need for bandwidth expands in LANs, WANs and SANs, serial backplanes become the ideal alternative for solving information bottlenecks. The current use of parallel buses in networking systems does not provide the performance required. Serial backplanes have clear advantages over parallel buses in that they utilize fewer wires and connectors, consume less power, can carry signals for longer distances, and ultimately offer higher performance and reliability. This allows the designer to connect boards that are separated by larger distances, together in the system. In addition, wiring harnesses are simplified because the designer does not need to run a large number of wires (as in a parallel bus), when a single pair of wires (as in a serial backplane) can be employed. This results in lower costs and higher performance. High performance is also achieved because serial approaches generate less crosstalk between parallel wires.

Many data communication vendors use 10BASE-T (10 Mbps) or 100BASE-T (100 Mbps) Ethernet as a communication channel between the different cards in a piece of telecom equipment. 10BASE-T or 100BASE-T form the communication channel among cards in the system. They do this by providing a physical link consisting of two pairs of signals routed on the backplane. One par of signals is used for the receive channel and one pair is used for the transmit channel. The 100BASE-T communications channel can be used for general card control, software maintenance, establishing in-band NMS (Network Management System) links and for alarm reporting. It is not used for processing or switching data. As the system grows and more cards are added, the bandwidth of the 10BASE-T or 100BASE-T channels gets consumed, thus slowing down the performance of the system.

Gigabit Ethernet offers a solution to the problem. However the Gigabit Ethernet standard for transmission over copper, 1000BASE-T, requires four pairs of signals: two pairs of signals for transmit and two pairs for receive. It is very difficult and expensive to redesign the backplanes to accommodate this standard because of the installed customer base that would not be able to benefit from this enhancement. Replacing a backplane in the field would mean that the entire system would have to be replaced. Furthermore, it is desirable to stay backwards compatible with the existing installed legacy cards. This problem is not unique to a single system vendor because the standard for using four pairs of wires for 1000BASE-T was not formally completed when the backplanes for many system vendors were first designed. To differentiate Gigabit Ethernet from other versions of Ethernet, those versions of Ethernet that operate at or below 100 Mbps are classified as high-speed Ethernet.

It would, therefore, be desirable to provide an interface device and method to seamlessly upgrade 2-pair copper transmission lines based serial backplane from Ethernet to Gigabit Ethernet while allowing both Ethernet and gigabit Ethernet based cards to coexist in the same system.

### SUMMARY OF THE INVENTION

The present invention provides an interface device and method to seamlessly upgrade 2-pair copper transmission lines based serial backplane from Ethernet to Gigabit Ethernet while allowing both Ethernet and gigabit Ethernet based cards to coexist in the same system.

An interface device has a plurality of ports with a plurality of speed configurations for a serial backplane with 2-pair copper transmission lines. The interface device has a plurality of high speed Ethernet ports and a plurality of Gigabit Ethernet ports. A switch mechanism for selecting between the high speed Ethernet ports and the Gigabit Ethernet ports connects the selected port to the serial backplane via the 2-pair copper transmission lines.

A serial backplane has 2-pair copper transmission lines having two interface devices. The interface devices have a plurality of communication cards with different Ethernet speed configurations connected via the ports. A communication method for two of the communication cards on each of two interface devices to communicate with each other across the serial backplane includes the following steps: a first card initiates contact with a second card via a negotiating method and then initiates the switching mechanisms to connect either a high speed Ethernet port or a Gigabit Ethernet port of the two cards to the serial backplane via the 2-pair copper transmission lines.

### BRIEF DESCRIPTION OF THE DRAWINGS

The invention will be more fully understood from the following detailed description taken in conjunction with the accompanying drawings, in which:

FIG. 1 is a schematic diagram of a typical conventional high speed Ethernet based serial backplane for a communication system.

FIG. 2 is a schematic representation of an embodiment for a Gigabit Ethernet capable 2 pair copper transmission line based serial backplane in accordance with an embodiment of the present invention.

FIG. 3 is a flowchart illustrating the communication process for two cards connected to serial backplane via the interface devices in the illustrative embodiment of the present invention.

### DETAILED DESCRIPTION OF THE INVENTION

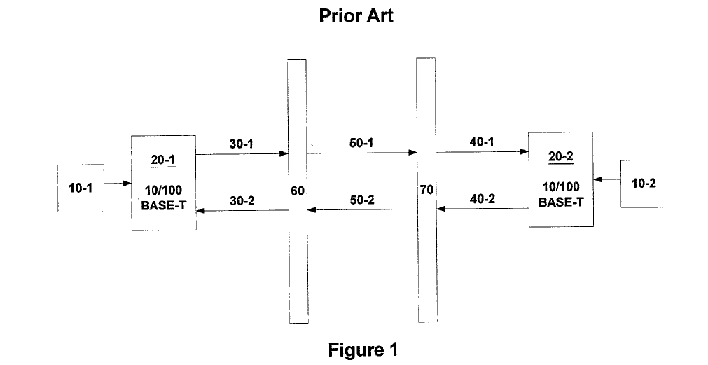

Referring to the drawings, FIG. 1 schematically illustrates a typical conventional high speed Ethernet based serial backplane for a communication system, such as an SN 16000 optical switch from Sycamore Networks, Chelmsford, MASS. Two communication cards 10-1 and 10-2 are plugged into ports of 10/100 BASE-T interface devices 20-1 and 20-2 respectively and then connected to a serial backplane via two backplane connectors 60 and 70. A communication card can be one of many field-replaceable microprocessor-based slave cards responsible for handling network traffic or it can be a field-replaceable microprocessor-based master card that is responsible for managing the slave cards. The backplane is the non-replaceable fixed medium by which the slave cards communicate with the master card. The backplane in FIG. 1 is delineated by the region between the backplane connectors 60 and 70. There are two pair copper transmission lines 50-1 and 50-2 in the serial backplane. Correspondingly, interface device 20-1 for card 10-1 communicates with the serial backplane via 2 pairs 30-1 for transmit and 30-2 for receive, and interface device 20-2 for card 10-2 communicates with the serial backplane via two pairs 40-1 for receive and 40-2 for transmit. The span of backplane, such as the distance between backplane connector 60 and 70, is relatively short, normally in the range 2″ to 40″. Cards 10-1 and 10-2 communicate with each other across the backplane via the two pair copper transmission lines for purposes such as general card control, software maintenance, establishing in-band NMS (Network Management System) links and alarm reporting. The two pair copper transmission lines are not used for processing or switching network traffic. The interface device can be a custom ASIC (application specific IC), or an off-the-shelf 10/100 Mbs Ethernet MAC (media access device) coupled with a 10/100BASE-T Ethernet Layer 1 transceiver.

As the system grows and more cards are added, the bandwidth of the 10BASE-T or 100BASE-T channels gets consumed, thus slowing down the performance of the telecom device. Gigabit Ethernet offers a solution to the problem, however, the Gigabit Ethernet standard for transmission over copper, 1000BASE-T, requires four pairs of signals: two pairs of signals for transmit and two pairs for receive. Fortunately a Serdes (SERializer-DESerializer) interface provides a point-to-point path from parallel to serial that uses 2 pairs lines, which is ideal to connect with a 2 pair copper transmission lines based serial backplane. The higher the data rate, the shorter the transmission distance must be. This means that closer attention must be paid to data integrity. One reason for Gigabit Ethernet over Copper standard to use 4 pair transmission lines is to support relatively long distance (100 meters) so each pair equivalently carries data at a rate of 250 Mbps. For general serial backplane applications, due to the relatively short distance (around 40″), 2 pairs using a Serdes interface is sufficient to maintain data integrity.

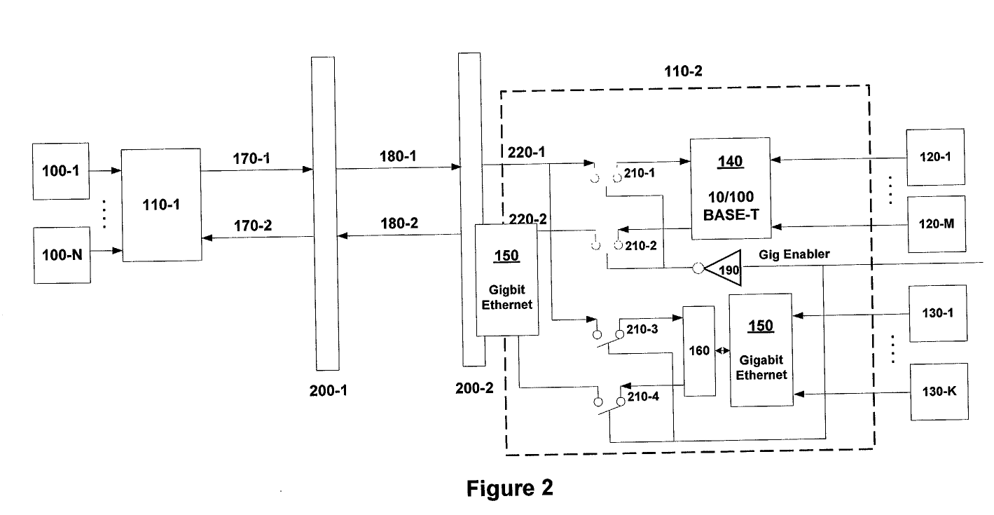

As illustrated in FIG. 2, in accordance with one aspect of the invention, two interface devices 110-1 and 110-2 are located at two sides of a serial backplane, having 2 pair copper transmission lines 180-1 and 180-2. The interface device can be one or more custom ASICs (application specific ICs), or an off-the-shelf 10/100/1000 Mbs Ethernet MAC (media access device) coupled with a 10/100BASE-T Ethernet Layer 1 transceiver (PHY) that also provides an IEEE 802.3z interface to which a SERDES can be connected. To complete the interface device, a bank of analog switches or relays are used to switch between the serial interface on the SERDES and the 10/100BASE-T interface on the PHY. A plurality of cards 100-1, . . . 100-N are plugged into the interface device 110-1 via ports on the interface device 110-1. A communication card can be one of many intelligent slave cards responsible for handling network traffic or it can be an intelligent master card that is responsible for managing the slave cards. A card that does not have a microprocessor on it is not an intelligent card and therefore is not a communication card. The interface device 110-1 is further connected to the backplane using 2 pair copper lines 170-1 for transmit and 170-2 for receive via backplane connector 200-1. A detailed schematic of the same interface card 110-2 as 110-1 is described as in FIG. 2, which further includes a traditional 10/100 BASE-T interface 140 having a plurality of legacy cards 120-1, . . . 120-M connected, and a Gigabit Ethernet interface 150 having a plurality of new Gigabit Ethernet capable cards 130-1, . . . 130-K connected. The Gigabit Enabler logic 190 controls the connection of either legacy 10/100 BASE-T interface 140 or Gigabit Ethernet interface 150 to serial backplane using 2 pair copper lines 220-1 for receive and 220-2 for transmit via backplane connector 200-2. The Gigabit Enabler logic 190 functions by controlling switch mechanism 210-1, 210-2, 210-3 and 210-4. The Gigabit Ethernet interface 150 is first connected to a Serdes interface 160 before switched to the 2 pair transmission lines 220-1 and 220-2. The 10/100 BASE-T interface 140, Gigabit Ethernet interface 150 and Serdes interface 160 can be implemented using Off the shelf products such as Intel's 82546 integrated dual MAC/PHY/SERDES device, or Broadcom's BCM5700 coupled with Broadcom's BCM5421S.

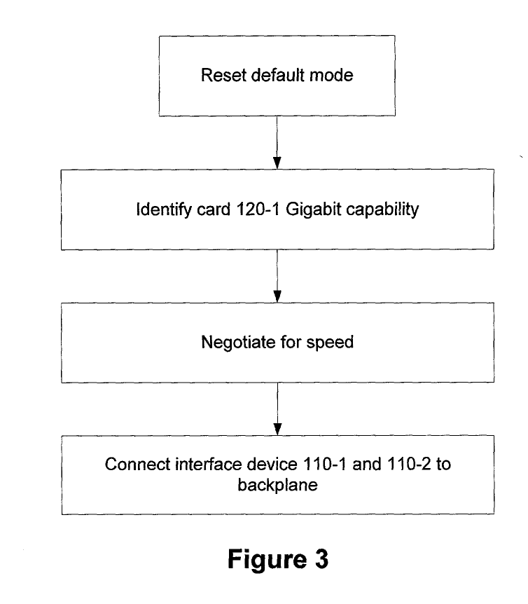

To further demonstrate how the interface device works, FIG. 3 illustrates the communication process between two cards 100-1 (which is a new Gigabit Ethernet enabled card) and 120-1 (which is a legacy 100 BASE-T card). First, the default mode for card 100-1 and 120-1 are reset to the lowest Ethernet speed such as 10BASE-T or 100BASE-T. Then a first card, such as 100-1, initiates the contact with card 200-1 by first identifying card 200-1's Gigabit capability. One way of doing this is by reading card 200-1's identification stored in PROM, among many possible implementations. Card 100-1 starts negotiating for speed process by trying different speeds such as 10 Mbps, 100 Mbps, 1000 Mbps until the highest common speed between cards 100-1 and 120-1 is found. Card 100-1 and 100-2 default to 100BASE-T upon power-up. If card 100-1 is the master (management entity) and it is capable of Gig-E, it queries the slave or examines its ID PROM to determine this. If the Gig-E capable slave responds favorably to the query, the master switches to Gig-E and tries to establish communication. If the link drops as a result of either the master or slave being reset the interface resets to its default state (100BASE-T). Depending on the negotiated speed, the Gigabit enabler logic will switch either 10/100BASE-T or Gigabit Ethernet interface to the backplane via 2 pair copper transmission lines. For the illustrated example, the negotiated speed is 100BASE-T, the Gigabit enabler logic on the left side will connect Gigabit Ethernet interface within 110-1 to the backplane and the Gigabit enabler logic on the right side will connect 10/100BASE-T 140 interface within 110-2 to the backplane.

The illustrated embodiment provides a seamless upgrade path to a Gigabit Ethernet for a legacy 2 pair copper transmission lines based serial backplane when next generation Gigabit Ethernet based cards come on line. The illustrated interface device with multiple Ethernet speed configurations allows next generation cards to be backward compatible with the legacy cards while both next generation and legacy cards coexist in the same system.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. An interface having a plurality of ports with a plurality of speed configurations for a serial backplane with 2-pair copper transmission lines, comprising:
a plurality of high speed Ethernet ports;
a plurality of Gigabit Ethernet ports with a SERDES interface;
a switch mechanism for selecting between said high speed Ethernet ports and said Gigabit Ethernet ports and for connecting said selected port to said serial backplane via said 2-pair copper transmission lines.

2. The interface in claim 1 wherein said high speed Ethernet ports have a speed configuration of 10 b/s.

3. The interface in claim 1 wherein said high speed Ethernet ports have a speed configuration of 100 b/s.

4. The interface in claim 1 wherein said switch mechanism is an analog switch.

5. The interface in claim 1 wherein said switch mechanism is provided via relays.

6. The interface in claim 4 wherein the analog switch is a PHEMT (Pseudomorphic High Electron Mobility Transistor) switch.

7. In a device having a serial backplane with 2-pair copper transmission lines having two interface devices, said interface devices having a plurality of communication cards with either high speed Ethernet or Gigabit Ethernet speed configurations connected via said ports, a communication method for two of said communication cards on said each of two interface devices across said serial backplane, comprising steps of:
the first of said two cards initiating contact with the second of said two cards by a negotiating a highest common speed configuration among said two cards;
initiating said switching mechanisms to connect said two cards via said negotiated highest common speed configuration to said serial backplane via said 2-pair copper transmission lines.

8. The communication method in claim 7 wherein said negotiating method further comprising:
setting the default speed configurations for said two communication cards to high Ethernet speed;
the first of said two cards determining the common highest speed configuration for said two cards by trying different speeds in a continuous loop;

9. The method of claim 8 wherein the default speed is 10BASE-T.

10. The method of claim 8 wherein the default speed is 100BASE-T.

11. The method of claim 8 wherein the high speed Ethernet is 10 b/s.

12. The method of claim 8 wherein the high speed Ethernet is 100 b/s.
